(19) United States
(12) Patent Application Publication
(10) Pub. No.: US 2006/0189464 A1
(43) Pub. Date: Aug. 24, 2006

(54) Machine tool with tool magazine

(76) Inventors: Ioan-Mircea Corbean, Marbach (DE); Tobias Ruckwied, Fellbach (DE); Gerald Stengele, Ludwigsburg (DE)

Correspondence Address: MCGLEW & TUTTLE, PC, P.O. BOX 9227, SCARBOROUGH STATION, SCARBOROUGH, NY, 10510-9227, US

(21) Appl. No.: 10/550,417

(22) PCT Filed: Mar. 30, 2004
(86) PCT No.: PCT/EP04/00331

§ 371 Date: Sep. 20, 2005

(30) Foreign Application Priority Data
Apr. 15, 2003 (DE) 203 06 087.3

(51) Int. Cl. B23Q 3/155

(52) U.S. Cl. 483/63

(57) ABSTRACT

A machine tool comprises a tool magazine (48) which comprises an endless chain (51) that is circulatorily drivable and provided with tool-holding fixtures (56). The tool magazine (48) is angular, having a substantially horizontal top limb (61) and a bottom limb (57) which extends downwards. The chain (51) extends substantially through both limbs (57, 61). A fitting location (59) is provided in the bottom limb (57).

The invention relates to a machine tool according to the preamble of claim 1.

A machine tool of the generic type is described in JP 11-99 427 A. In this machine tool, the tool magazine is disposed on a rearward side wall. Mounted between the chain that holds the tools and the working area is a tool-change arrangement which comprises a rotatable tool-change device. With the tool-change arrangement also being disposed between the magazine and the working area, the overall width of the machine tool increases. Important drawbacks arise in particular when the machine tool is a double-spindle machine tool, it being indispensable in this case to provide such a tool magazine with a tool-change arrangement on both sides. Additionally, the working area of the machine tool can no longer be seen.

DE 195 03 482 C2 (corresponding to EP 0 806 998 B1) teaches a machine tool of the generic type, in which the tool magazine is disposed above the working area on the frame of the machine. In this machine tool, the holding fixtures of the chain that holds the tools are embodied such that the tool-holder spindle deposits the used tool directly into an empty tool-holding fixture of the chain and then picks up another tool from a holding fixture of the chain that has previously been equipped with another tool. In this arrangement, the working area is visible, but loading the chain with tools is difficult, with the tool-fitting location being located rather high.

It is an object of the invention to embody a machine tool of the generic type in such a way that the visibility of the working area is maintained while fitting the magazine with tools is very easily possible, accompanied with as little space as possible being necessary for the tool magazine.

According to the invention, this object is attained by the features of the characterizing part of claim 1. The gist of the invention resides in that the space available above the working area and the frame of the machine tool, respectively, is used for the tool magazine, but that simultaneously a downward limb is available on a rearward side wall, into which extends the chain that is circulatorily drivable so that an operator can proceed very conveniently and efficiently with changing tools on the chain.

Claims 2 and 3 reflect advantageous further developments of this.

The advantages of the solution according to the invention are helpful in particular in the embodiment of the machine tool according to claim 4.

Claims 5 f. reflect advantageous embodiments of a tool-change arrangement for use together with the tool magazine.

Further features, advantages and details of the invention will become apparent from the ensuing description of an exemplary embodiment, taken in conjunction with the drawing, in which

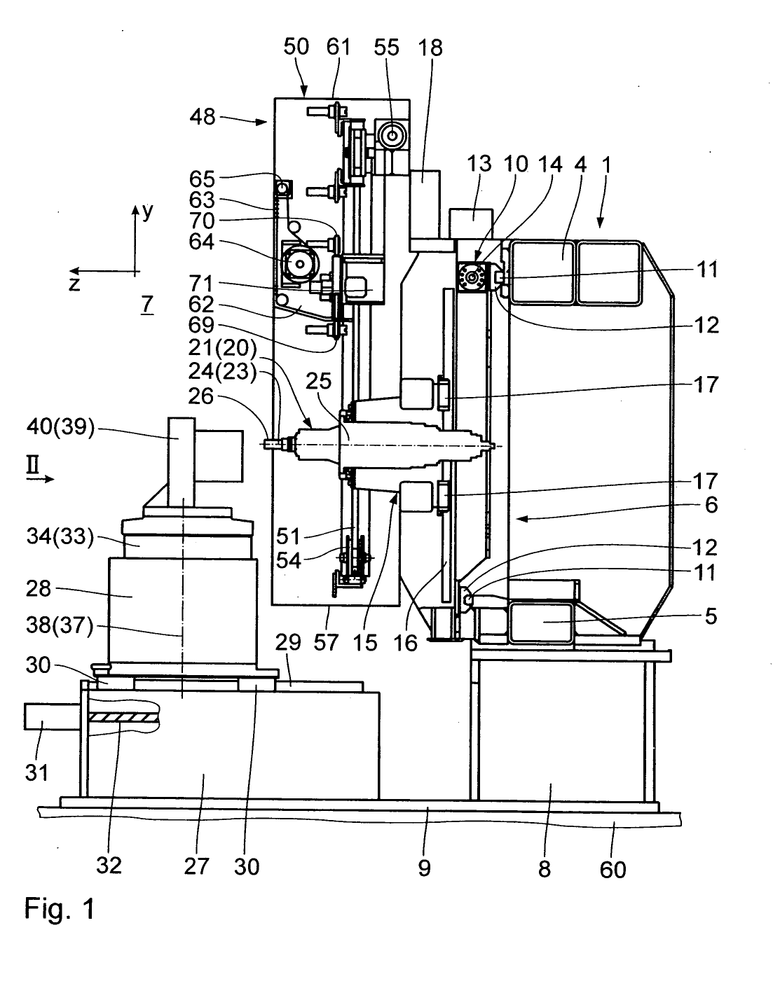

FIG. 1 is a lateral longitudinal view of a double-spindle machine tool;

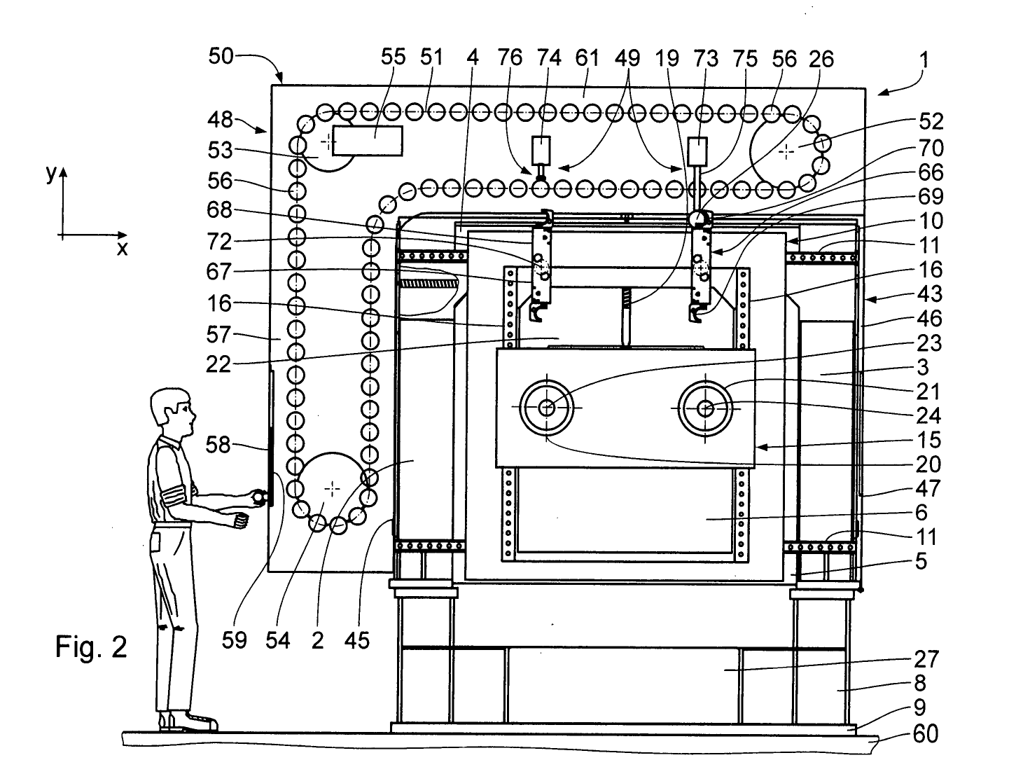

FIG. 2 is an elevation of the machine tool in accordance with the arrow II of FIG. 1;

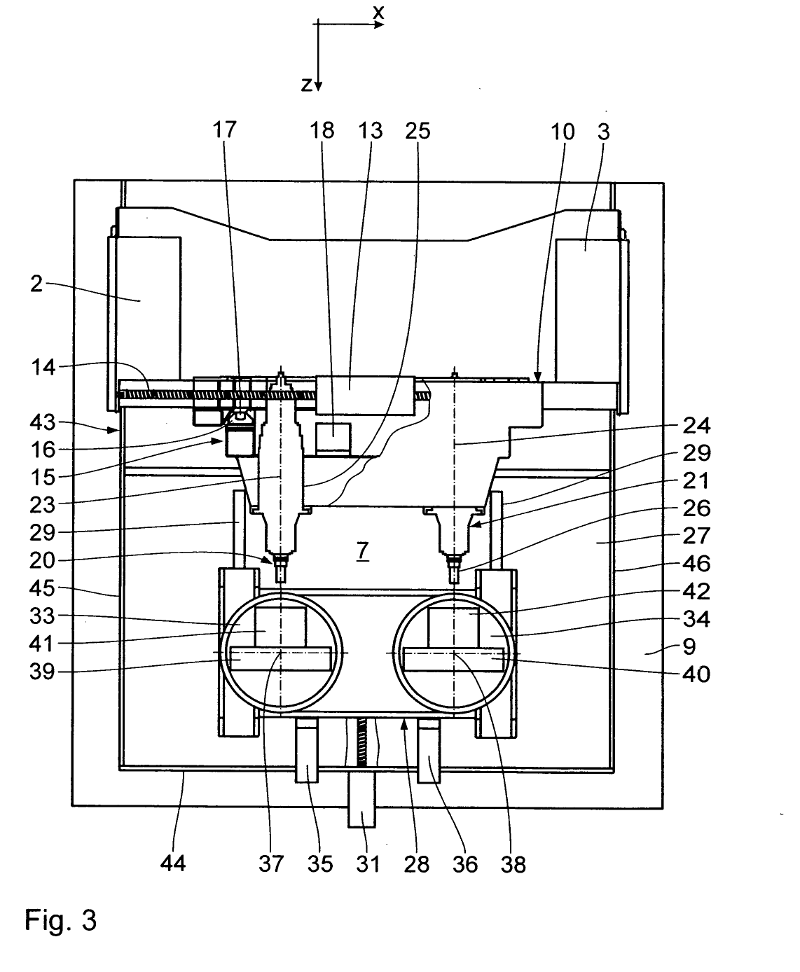

FIG. 3 is a plan view of the machine tool in accordance with the arrow III of FIG. 1; and

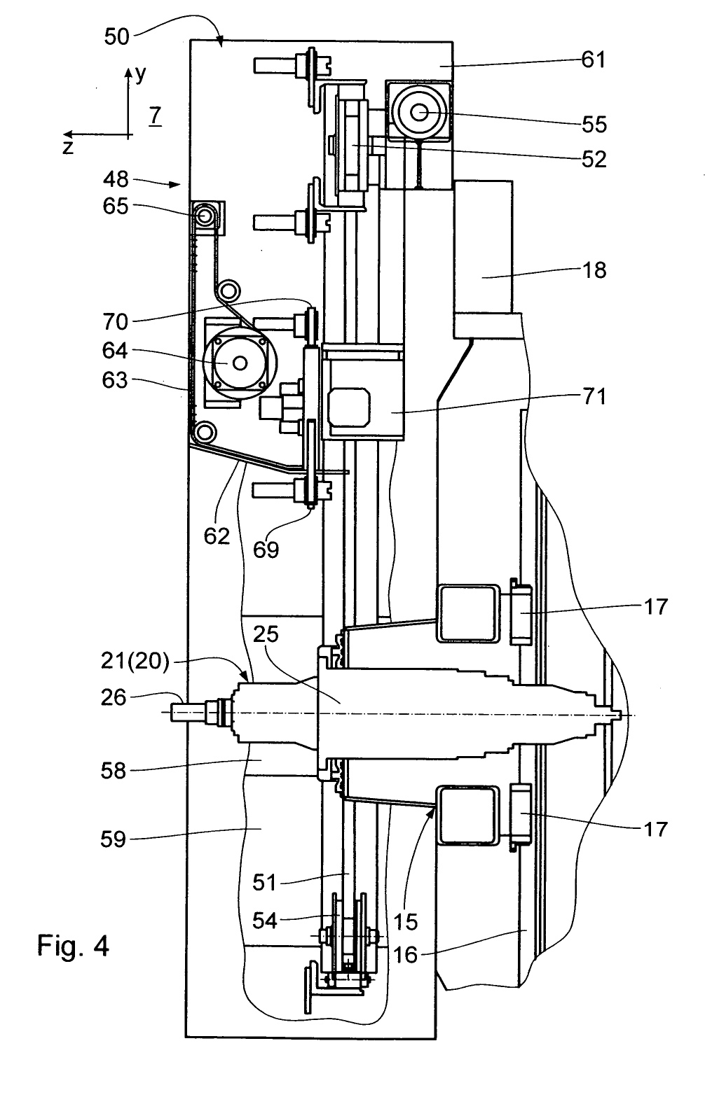

FIG. 4 is an illustration, on an enlarged scale, of details of FIG. 1.

The first exemplary embodiment of a double-spindle machine tool illustrated in the drawing—seen in the horizontal z direction—comprises a rectangular, approximately square frame 1 which is formed by vertical side props 2, 3 that run in the y direction and by a horizontal top crossbeam 4 that runs in the x direction and unites the props 2, 3 a bottom crossbeam 5. The side props 2, 3 and the crossbeams 4, 5 are formed by hollow sections and enclose an interior 6 which is open bilaterally, in particular towards the working area 7. By way of a subframe 8, the frame 1 supports itself on the foundation or on a foundation plate 9, respectively.

On the front side, turned towards the working area 7, of the frame 1, provision is made for an x skid 10 in the form of a frame which is movable in the x direction. To this end, the crossbeams 4, 5 are each provided with an x guide rail 11 on which the x skid 10 is guided by means of x guide shoes 12. Actuation of the x skid 10 takes place by means of an x motor 13, which is mounted on the x skid 10, by way of x ball screw 14 which runs in the x direction and is non-rotatably located in the side props 2, 3 of the frame 1.

A y skid 15 which is vertically movable i.e., in the y direction, is guided for displacement on the front side, turned towards the working area 7, of the x skid 10. To this end, a y guide rail 16 is mounted on the respective lateral areas of the frame-type x skid 10, on which the y skid 15 is guided for displacement by means of guide shoes 17. Actuation of the y skid 15 takes place via a y ball screw 19 by means of a y motor 18 which is also mounted on the x skid 10.

Two tool holder spindles 20, 21 are located at a distance from each other on the y skid 15; they extend in the z direction and forwards towards the working area 7 and backwards through the inner clearance zone 22 of the x skid 10 and into the interior 6 of the frame 1. The tool holder spindles 20, 21 are operable by a drive motor 25 for rotation about an axis 23, 24 which runs in the z direction. The z axes of rotation 23, 24 have a distance from each other in the x direction. On their side turned towards the working area 7, they can each accommodate a machining tool 26. In the x and y direction, the tool holder spindles 20, 21 are mounted stationarily one in relation to the other on the y skid 15, however they are non-displaceable in the z direction.

A work carrier bed 27 is located in the working area 7 in front of the stand 1 on the foundation or foundation plate 9, with a z skid 28 being located thereon for displacement in the z direction. To this end, the bed 27 is provided with z guide rails 29 on which the z skid is movably supported by z guide shoes 30. Actuation takes place via a z ball screw 32 by means of a z motor 31 which is mounted on the work carrier bed 27.

Two rotary tables 33, 34 are mounted on the z skid 28, each of which being drivable for rotation about a vertical axis of rotation 37, 38 i.e., in the y direction, by means of a rotary drive motor 35, 36. The y axes of rotation 37, 38 also have a distance from each other.

A work carrier 39, 40 is mounted on the y rotary tables 33, 34; it is able to accommodate a work piece 41, 42.

The simultaneous machining of the fundamentally identical work pieces 41, 42 by means of a tool 26 takes place in such a way the identical motions of the tool holder spindles 20, 21 are made in the x and y direction by means of the x skid 10 and the y skid 15. The—in this regard—identical motions of the work pieces 41, 42 in the z direction are performed by the z skid 28. Only the motions of the work pieces 41, 42 about the vertical y axes of rotation 37, 38 will also be fundamentally identical in practice, but can be different at least theoretically because of the independent actuation of the work carriers 39, 40 for rotation about the y axes of rotation 37, 38.

The machine tool is enveloped by a machine housing 43 (roughly outlined) which covers in particular the working area 7. It comprises a front wall 44, a rearward side wall 45 and an access side wall 46. An access door 47 or window is located in the access side wall 46.

The machine tool is provided with a tool magazine 48 and a tool-change arrangement 49. The tool magazine 48 has a magazine housing 50 of angular or L-shaped design, extending downwards beyond the working area 7 and outside the range of the rear side wall 45. An endless chain 51 is disposed in the magazine housing 50; it passes angularly or in the shape of an L along chain wheels 52, 53, 54, largely occupying the housing. One of the chain wheels 53 is drivable by a chain drive motor 55. The chain 51 is provided with numerous tool-holding fixtures 56 into which to insert tools 26 that extend horizontally in the z direction.

On a bottom limb 57 of the housing 50, which covers the rearward side wall 45, provision is made for a tool-fitting aperture 59 for closure by means of a cover 58 or flap, door or roller shutter, through which an operator, in a customary upright position of working, is able to insert tools 26 into the holding fixtures 56 and withdraw them. The tool-fitting aperture 59 is located in the bottom area of the bottom limb 57 of the housing 50 at a height of one to two meters above the ground 60.

The horizontal top limb 61 of the housing 50, on its bottom side turned towards the working area 7, comprises a tool-change opening 62 which can be closed by means of a roller shutter 63. It is drivable by means of a roller-shutter drive motor 64, passing along several deflection rolls 65 that are disposed in the casing 50. Of course, sliding doors, telescopic metal plates etc. may be used alternatively of roller shutters.

Two tool-change devices 66, 67, which constitute the tool-change arrangement 49, are disposed in the top limb 61 of the magazine housing 50; they comprise a respective tool-change arm 68, on both ends of which is disposed a respective claw 69, 70 for holding a tool. The change arms 68 are mounted centrically between the two claws 69, 70 on a change-arm drive 71. These change-arm drives 71 are embodied for rotation of the tool-change arms 68 about their axis of rotation 72 that runs in the z direction and for displacement in the direction of the axis of rotation 72. The tool-change devices 66, 67 are located vertically above the tool-holder spindles 20, 21, as seen in FIG. 2. Located above the tool-change devices 66, 67 and thus also vertically above the tool-holder spindles 20, 21 are two transfer devices 73, 74 which, at a tool-pick-up location 75, 76, take a respective tool 26 from a tool-holding fixture 56, moving it downwards so that it can be seized by a claw 69 or 70 of a tool-change device 66 and 67, respectively. Likewise, claws 69 and 70, respectively, of a tool-change device 66, 67 put a used tool 26 into the respective transfer device 73, 74 which returns it to the tool-holding fixture 56 of the tool magazine 58. This is roughly outlined in FIG. 2. Fundamentally, it is possible to use other tool-change arrangements. It is also conceivable to drop the tool-change arrangements and transfer devices and to pick the tools directly from the chain or place them there. Such a design is known for example from DE 195 03 482 C2 (corresponding to EP 0 806 998 B1).

Prior to the change of a tool, the tool-change devices 66, 67 are in their position of rest i.e., the respective change arm 68 is in a horizontal position of rest. For the change of a tool, the y skid 15 is being moved into a position of change, as a rule upwards. The change arms 68, together with the claws 69 and 70, are being rotated by 90° so that a claw 69 or 70 seizes a tool 26 that is located in a tool-holding fixture 56, while the other claw 70 or 69 seizes the tool 26 that is to be exchanged and located in the tool-holder spindle 20 and 21, respectively. Afterwards the change arms 68 are being advanced by the change-arm drive 71 towards the z skid 28, whereby the tools 26 are being withdrawn from the tool-holder spindle 20, 21 and the tool-holding fixture 56, respectively. Then the change arms 68 are being rotated by 180° so that the tool 26, which has been picked from the holding fixture 56, stands in front of the tool-holder spindle 20 and 21, respectively, whereas the tool 26, which has been removed from the tool-holder spindle 20 and 21, respectively, finds itself in front of the tool-holding fixture 56. Then the change arms 68 are being reversed towards the frame 1 by means of the drive 71, whereby the new tool 26 is being placed into the tool-holder spindle 20, 21 whereas the exchanged tool 26 is being placed into the transfer device 73 and 74. The claws 69, 70 are being opened, releasing the two tools 26. The respective change arm 68 is again being rotated by 90° into its position of rest. After the new tools 26 have been fitted in the tool-holder spindles 20, 21, the y skid 15 can again be displaced into its position of working and the exchanged tool 26 can be placed into the tool-holding fixture 56 of the chain 51 by means of the transfer devices 73, 74.

Prior to the change of a tool, the tool-change aperture 62 is being opened upwards by the roller shutter 62 being correspondingly moved. Directly after termination of a job of changing, the opening 62 is shut again so that no chips can get into the magazine housing 50.

1. A machine tool, comprising
a working area with a work carrier;
a tool-holder spindle,
which replaceably accommodates a tool that extends in a z direction, and
which is displaceable on an x-y plane;
and
a tool magazine,
which comprises an endless chain that is circulatorily drivable and provided with tool-holding fixtures;
wherein the tool magazines is angular, having a substantially horizontal top limb and a bottom limb which extends downwards;
wherein the chain extends substantially through the top limb and the bottom limb; and
wherein a tool-fitting aperture is provided in the bottom limb.

2. A machine tool according to claim 1, wherein the tool magazine comprises a magazine housing, in the bottom limb of which a tool-fitting aperture is formed.

3. A machine tool according to claim 2, wherein the tool-fitting aperture is provided with a movable cover.

4. A machine tool according to claim 1, wherein it is a double-spindle machine tool.

5. A machine tool according to claim 1, wherein a tool-pick-up location is provided in the tool magazine (48).

6. A machine tool according to claim 5, wherein a tool-change arrangement is provided between the tool-pick-up location and the tool-holder spindle.

7. A machine tool according to claim 6, wherein the tool-change arrangement is a rotatable tool-change device which has two claws for holding a respective tool.

8. A machine tool according to claim 7, wherein a transfer device is provided between the tool-pick-up location and the tool-change device.

9. A machine tool according to claim 6, wherein the tool-change arrangement is disposed above the tool-holder spindle.

10. A machine tool according to claim 1, wherein the top limb of the magazine housing is provided with a closable tool-change opening.

11. A machine tool according to claim 10, wherein the tool-change opening is closable by a roller shutter.
